(19) United States
(12) Patent Application Publication
(10) Pub. No.: US 2021/0297864 A1
(43) Pub. Date: Sep. 23, 2021

(54) Backhaul Estimation Scheduling

(71) Applicant: Parallel Wireless, Inc., Nashua, NH (US)

(72) Inventors: Gaurav Kumar, Nashua, NH (US); Rajesh Kumar Mishra, Westford, MA (US)

(21) Appl. No.: 17/206,115

(22) Filed: Mar. 18, 2021

Related U.S. Application Data
(60) Provisional application No. 62/991,582, filed on Mar. 18, 2020.

(51) Int. Cl. H04W 16/02; H04W 24/08

(52) U.S. Cl. CPC H04W 16/02; H04W 24/08

(57) ABSTRACT

Methods and computer software are disclosed for providing backhaul bandwidth estimation for a network. In one embodiment a method is disclosed, comprising: performing active measurements of a maximum achievable bandwidth for the network; determining an uplink direction bandwidth estimation for the network; determining a downlink direction bandwidth estimation for the network; and determining, using the uplink direction bandwidth estimation and the downlink direction estimation bandwidth, a bandwidth estimation conclusion for the network.

### CROSS-REFERENCE TO RELATED APPLICATIONS

This application claims priority under 35 U.S.C. § 119(e) to U.S. Provisional Pat. App. No. 62/991,582, filed Mar. 18, 2020, titled “Backhaul Estimation Scheduling,” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828427, U.S. Pat. App. Pub. Nos. US20170273134A1, US20170127409A1 in their entirety.

### BACKGROUND

Radio spectrum and transport (backhaul) resources are limited, expensive and shared among many users and services. Mobile broadband networks must support multiple applications of voice, video and data on a single IP-based infrastructure. These converged services each have unique traffic handling and QoE requirements.

3GPP defines different types of QoS classes mechanism based on the involved technology: four 3G QoS classes: Conversational; Streaming; Interactive; and Background, instead 4G QCI concept.

### SUMMARY

It is desirable to consider possible technology able to manage in the best way both the real available resource (in this case the backhauling bandwidth) and the relevant management in order to respect the necessary traffic QoS characteristics during the services deliver to the users.

One methodology, along with the already available QoS mechanism (Traffic Prioritization and Traffic Shaping) that are able to avoids congestion at backhauling interface, introduces an adaptive real-time estimation mechanism that can estimate the available bandwidth, in particular, on the LTE backhauling link to help provide carrier-class service to the served entities avoiding that static configured value can lead to e.g. of high priority traffic.

In one embodiment, a method may be disclosed, comprising: performing active measurements of a maximum achievable bandwidth for the network; determining an uplink direction bandwidth estimation for the network; determining a downlink direction bandwidth estimation for the network; and determining, using the uplink direction bandwidth estimation and the downlink direction estimation bandwidth, a bandwidth estimation conclusion for the network.

In another embodiment, a non-transitory computer-readable medium containing instructions for providing backhaul bandwidth estimation for a network that when executed, causes a network to perform steps comprising: performing active measurements of a maximum achievable bandwidth for the network; determining an uplink direction bandwidth estimation for the network; determining a downlink direction bandwidth estimation for the network; and determining, using the uplink direction bandwidth estimation and the downlink direction estimation bandwidth, a bandwidth estimation conclusion for the network.

### BRIEF DESCRIPTION OF THE DRAWINGS

FIG. 1 is a diagram showing a QoS architecture 100 in LTE.

FIG. 2 is a flow diagram showing Bandwidth Estimation output and input to other functions, in accordance with some embodiments.

FIG. 3 is a flow diagram of an example process for estimating bandwidth, in accordance with one embodiment.

FIG. 4 is a diagram showing a Bandwidth Estimation procedure (Positive Scenario) overview, in accordance with some embodiments.

FIG. 5 is a diagram showing a Bandwidth Estimation procedure (Negative Scenario—Request denied) overview, in accordance with some embodiments.

FIG. 6 is a diagram showing a Bandwidth Estimation procedure (Negative Scenario—No connection to the iPerf Server) overview, in accordance with some embodiments.

FIG. 7 is a diagram showing a Bandwidth Estimation procedure—Multiple PW-BH(s) Requests Overview, in accordance with some embodiments.

FIG. 8 is a flow diagram showing a bandwidth estimator procedure, in accordance with some embodiments.

FIG. 9 is a call flow diagram for determining DL bandwidth for each type of traffic and creating shaping rules, in accordance with some embodiments.

FIG. 10 is a network diagram, in accordance with some embodiments.

FIG. 11 is a schematic network architecture diagram for 3G and other-G prior art networks.

FIG. 12 is an enhanced eNodeB for performing the methods described herein, in accordance with some embodiments.

FIG. 13 is a coordinating server for providing services and performing methods as described herein, in accordance with some embodiments.

### DETAILED DESCRIPTION

LTE uses a class-based QoS concept, which reduces complexity while still allowing enough differentiation of traffic handling and charging by operators. Bearers can be classified into two categories based on the nature of the QoS they provide: Minimum Guaranteed Bit Rate (GBR) bearers and Non-GBR bearers.

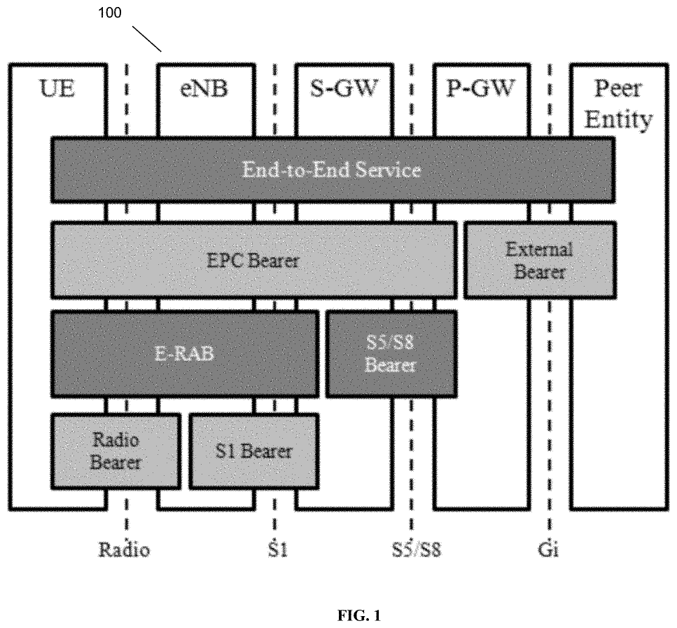

FIG. 1 shows the QoS architecture 100 in LTE. To ensure that bearer traffic in LTE networks is appropriately handled, a mechanism is defined to classify the different types of bearers into different classes, with each class having appropriate QoS parameters for the traffic type.

QoS Class Identifier (QCI) is the mechanism used in 3GPP LTE networks to ensure bearer traffic is allocated appropriate Quality of Service (QoS): different bearer traffic requires different QoS and therefore different QCI values.

QCI values are standardized to reference the specific QoS characteristics and each QCI contains standardized performance characteristics (values) such as resource type (GBR or non-GBR), priority, Packet Delay Budget and Packet Error Loss Rate.

The broadband capability of data application in LTE is one of the main reasons for adopting LTE for mission critical communication as well. Since LTE can supports simultaneously voice and data calls, in case of highload, it can prioritize certain applications for resources allocation; for example, voice communication is the most important service which makes it high priority. Public safety operators planning to use LTE for mission critical services that need a different level of latency, jitter and throughput requirement in voice and data applications. It also has to be managed by the network when forwarding the application packets.

3GPP, in addition to the original 9 QCIs (QCI 1-9) of R.8, introduced a new set of QCIs to support mission critical activities in a public safety environment: QCI-65, QCI-66, QCI-69 and QCI-70 were introduced in 3GPP TS 23.203 Rel-12 for this purpose (QCI-75 and QCI-79 were introduced in R.14).

Table 1 shows the list of QCI supported in 3GPP Release 12 that are also supported

TABLE 1
3GPP R12 and Public Safety Release QCI supported

| | Bearer | | | | |
|---|---|---|---|---|---|
| QCI | Type | Priority | Delay | Loss | Service Example |
| 1 | GBR | 2 | 100 ms | 10⁻² | VOIP call |
| 2 | | 4 | 150 ms | 10⁻³ | Video call |
| 3 | | 3 | 50 ms | 10⁻³ | Online gaming |
| 4 | | 5 | 300 ms | 10⁻⁶ | Video streaming |
| 65 | | 0.7 | 75 ms | 10⁻² | Mission critical PTT voice |
| 66 | | 2 | 100 ms | 10⁻² | Non-mission critical PTT voice |
| 5 | Non- | 1 | 100 ms | 10⁻⁶ | IMS signaling |
| 6 | GBR | 6 | 300 ms | 10⁻⁶ | Video, TCP based services |
| 7 | | 7 | 100 ms | 10⁻⁶ | Voice, video, interactive gaming |
| 8 | | 8 | 300 ms | 10⁻⁶ | Video, TCP based services |
| 9 | | 9 | 300 ms | 10⁻⁶ | Mission critical delay |
| 69 | | 0.5 | 60 ms | 10⁻⁶ | sensitivity signaling |
| 70 | | 5.5 | 200 ms | 10⁻⁶ | Mission critical data |

The DSCP mechanism is one of the most used QoS mechanism in IP environment. It comes from the DiffServ framework as defined by the IETF. Diffserv is a coarse-grained, class-based mechanism for traffic management that relies on a mechanism to classify and mark packets as belonging to a specific class. DiffServ-aware routers implement per-hop behaviors (PHBs) that define the packet-forwarding properties associated with a class of traffic. Different PHBs may be defined to offer, for example, low-loss or low-latency.

DiffServ operates on the principle of traffic classification, where each data packet is placed into a number of traffic classes: each router on the network is configured to differentiate traffic based on its class. Each traffic class can be managed differently, ensuring preferential treatment for higher-priority traffic on the network.

While DiffServ does recommend a standardized set of traffic classes, see Table 2, the DiffServ architecture does not incorporate predetermined judgments of what types of traffic should be given priority treatment. DiffServ simply provides a framework to allow classification and differentiated treatment. The standard traffic classes serve to simplify interoperability between different networks and different vendors' equipment.

TABLE 2

| | TOS | | DSCP/ |
|---|---|---|---|
| TOS | Precedence | DSCP | PHB |
| (Dec) | Name | (Dec) | Class |
| 0 | Routine | 0 | none |
| 4 | Routine | 1 | none |
| 8 | Routine | 2 | none |
| 12 | Routine | 3 | none |
| 16 | Routine | 4 | none |
| 32 | Routine | 8 | cs1 |
| 40 | Routine | 10 | af11 |
| 48 | Routine | 12 | af12 |
| 56 | Routine | 14 | af13 |
| 64 | Immediate | 16 | cs2 |
| 72 | Immediate | 18 | af21 |
| 80 | Immediate | 20 | af22 |
| 88 | Immediate | 22 | af23 |
| 96 | Flash | 24 | cs3 |
| 104 | Flash | 26 | af31 |
| 112 | Flash | 28 | af32 |
| 120 | Flash | 30 | af33 |
| 128 | Flash Override | 32 | cs4 |
| 136 | Flash Override | 34 | af41 |
| 144 | Flash Override | 36 | af42 |
| 152 | Flash Override | 38 | af43 |
| 160 | Critical | 40 | cs5 |
| 176 | Critical | 44 | voice-admit |
| 184 | Critical | 46 | ef |
| 192 | InterNetwork | 48 | cs6 |
| | Control | | |
| 224 | Network | 56 | cs7 |
| | Control | | |

Note: in Table 2 are also reported the equivalent previous, i.e. before the DS (DSCP,ECN) field replacement of outdated IPv4 TOS field, TOS information (TOS value, TOS Precedence).

DSCP marking is performed using the following profiles: LTE QoS mapping, Downlink/Uplink QoS, and DSCP Profile. In any deployment scenario, either the uplink or the downlink backhaul link could get congested under severe traffic conditions or bad radio conditions.

Using a static mechanism to handle backhaul traffic has certain limitations, such as: in good network conditions, the available bandwidth would be under-estimated leading to the throttling of traffic that the network could have handled; and in bad conditions, the actual bandwidth available could be less than the configured static value, which could cause loss of high priority traffic leading to network outages (the same situation as being without any policies).

It is important for the RANs to accurately estimate the bandwidth available on the LTE backhaul links to be able to provide carrier-class service to the served entities. The availability of a reliable, real-time backhaul bandwidth estimation mechanism on top of existing traffic management functions will permit to prevent link congestion at backhaul between gateway PW-BH (GWPW-BH) and HNG.

The PW-BH supports the LTE modem (Category 3) interface, which is capable of a rated capacity of 100 Mbps downlink and 50 Mbps uplink on the air-interface. This interface can be used at a gateway node(GW PW-BH) to provide interconnection for multiple PW-BH(s)/PW-eNBs connected over the Mesh: backhaul congestion handling involves the backhaul link capacity between the GW PW-BH and the HNG.

Prioritization of traffic ensure that the higher priority traffic made it to the gateway node. However, it could not always prevent the uplink from getting congested. The additional improvement to the backhaul congestion handling provides the additional capability for congestion control of the backhaul link capacity between a GW PW-BH and the HNG. The overall function can be summarized as follows: at the HNG the downlink traffic is prioritized and shaped for each of the configured; PW-BH(s) i.e. GW PW-BH(s) and Mesh PW-BH(s); PW-eNB(s) i.e. GW PW-eNB(s) and Mesh PW-eNB(s); at each PW-BH/PW-eNB the uplink traffic is prioritized and shaped; the GW PW-BH(s)-HNG UL and DL backhaul link capacity is real-time estimated/derived and feedback to the traffic shaping in case of Public Safety deployment or configured by the Operator in case of non-Public Safety deployment' and the LTE Access Admission and Congestion control implemented at the PW-eNB level is leading with the LTE associated reported backhaul bandwidth for relevant admission of the users' services and/or recovery from a possible relevant congested state in case of Public Safety deployment.

One solution categorizes the overall traffic in the following logical classes: Control: absolute minimum control traffic that needs to be supported to keep the services up, without causing large scale disruptions in the network, e.g. heartbeats, SON, critical OAM traffic; Signaling-traffic: Signaling traffic for the various access services; UMTS-Voice: 3G Voice users traffic; UMTS-Data: 3G Data users traffic; and LTE Data: LTE Data users traffic.

Traffic prioritization identifies and classifies traffic into various priorities based on how critical it is to the network. DSCP/TOS markings assigned to this traffic are used end-to-end in the network. In the case of congestion, each network element in the route makes an informed decision about what traffic to drop.

The QoS through DSCP marking can be managed using different profiles that meet different use cases and network elements relationships. The three level of management include: LTE QCI level; HNG-PW-BH (GW PW-BH) interconnection level (Downlink and Uplink).

An algorithm able to meet the competing demands of accuracy and bandwidth efficiency is used with the target to estimate, via measurement, the bandwidth of the backhaul link. The basic idea is the availability of an algorithm that evaluate a closely estimation of the available bandwidth of the backhaul link with the LTE macro network using an existing market tool able to obtain the estimation with a real measurement of the link based on the analysis of the intentional injected traffic in the link.

The reliable bandwidth estimation technique used requires a cooperative activity between two logic entities: the sender and the receiver where the sender is the entity that generates the traffic that will be measured by the receiver. In this context the two entities are the GW PW-BH (GW CCH) and the relevant HNG, that is the network entity through which all the traffic flows.

More in particular the algorithm makes use of the market tool iPerf3 and so in this iPerf context the GW PW-BH will be considered as the iPerf3 client and the HNG as the iPerf3 server. So in the HNG will be available an iPerf server functionality that will be automatically enabled when the operator configurable parameter mode will be set to enable: this will basically enable the feature itself from HNG view point permitting so to the HNG to act as iPerf server and managing so the incoming GW PW-BH request for bandwidth estimation procedure via the iPerf connection. If for any reason the start of the iPerf Server functionality in the HNG will not succeed (at any occasion it can happen, including the restarting scenario)then the HNG will notify a dedicated alarm (the iPerf server did not successfully start or restart, trapname pwIperfServerStartFadureAlarmNotif) that will be cleared when the HNG as iPerf Server will (re)start to work correctly.

Due to the intrinsic nature of algorithm technology used (filling in the pipe to be measured), the algorithmwill consider that: dedicated conditions; and dedicated scenario/use case must be meet and considered in order to evaluate the possibility (condition) to real execute (scenario/usecases) the Bandwidth Estimation procedure.

The above means that the following condition must be meet and following scenario/uses case are supported: the PW-BH will be in the position to start the bandwidth estimation when the following two basics condition are meet: the PW-BH is a GW node; and the Handbrake is on.

The above condition means that the following scenario are covered in terms of supported scenario for bandwidth estimation test execution: Car with gateway device (PW-BH) stop (handbrake on) and it is working as GW(connection to the macro is available): PW-BH Mesh Node become GW node (assuming handbrake is already on as expected); PW-BH reboot (assuming he will be again GW node and handbrake is on); LTE Modem Reboot (assuming he will be again GW node and handbrake is on); and IPsec down and up (assuming he will be again GW node and handbrake is on): this cover scenario as e.g. loss and reacquiring of LTE Macro connection.

Considering all the above, the feature is basically characterizing as per following overview: iPerf3 is preferentially used as tool for the link bandwidth estimation in each of the direction (UL and DL); GW PW-BH will be considered as the iPerf3 client and the HNG as the iPerf3 Server (and so no external, to the HNG, iperf3 Server can be used); the System and the Network Elements need to be configured for the Bandwidth estimation execution; the GW PW-BH will always start the procedure if the conditions are meet and if in the supportedscenario/use cases (assuming the parameters have been provisioned); The bandwidth estimation, when executed, in the supported scenario (i.e. after obtaining the relevant value), is not repeated until when an, of the, supported scenario is meet again: this means that no periodic bandwidth estimation is executed; Until when the bandwidth estimation procedure is running, no bandwidth is assigned to any possible node asking for it: this means that no previous or default backhaul bandwidth isconsidered as available; if a supported scenario re-trigger the bandwidth estimation procedure then this is considered asa fresh procedure i.e. as it happen for the first time and so all the relevant conditions apply.

The underlined algorithm, further explored below, is considered applicable in relation to a backhaul link to the HNG using an LTE macro network and in the context of a Public Safety deployment. This need to be, on top of the other, specific to the algorithm, enabling factors, properly configured in the staging of the PW-BH otherwise will be considered by definition disabled together the associated Mesh node Admission Control function.

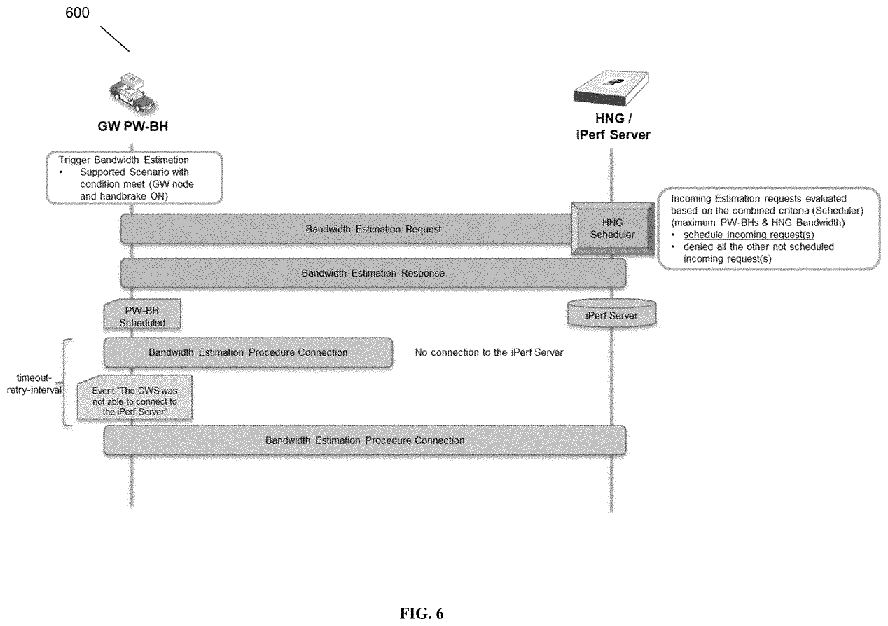

Finally, the output of the algorithm will be then used by all the relevant system functions (e.g. Mesh nodeAdmission Control, Traffic Shaping) without considering how this output has been obtained: for the relevant functions the algorithm methodology used for calculation and validation of the backhaul bandwidth estimation is not relevant at all and not impacting the relevant way to work. These functions are unaware-bandwidth estimation function capable and any future change in backhaul estimation algorithm from, e.g., methodology, parameters, iteration, process and so on, will not generate any necessary change or new implementation. The bandwidth estimation algorithm is a plug-and-play conceptin the end to end scenario (see FIG. 6).

Basically, the determined backhaul bandwidth is then used as a reference by the GW PW-BH in relation to the Mesh based Admission Control feature where, basically, each requested Node (GW/Mesh PW-BH/PW-eNB) bandwidth needs to fit in order to accept, from bandwidth allocation view point, the same node in the just joined Mesh Network (and that will also be used by the traffic shaping itself).

Where iPerf is described and discussed herein, any other similar or equivalent tool may also be understood to be able to be used.

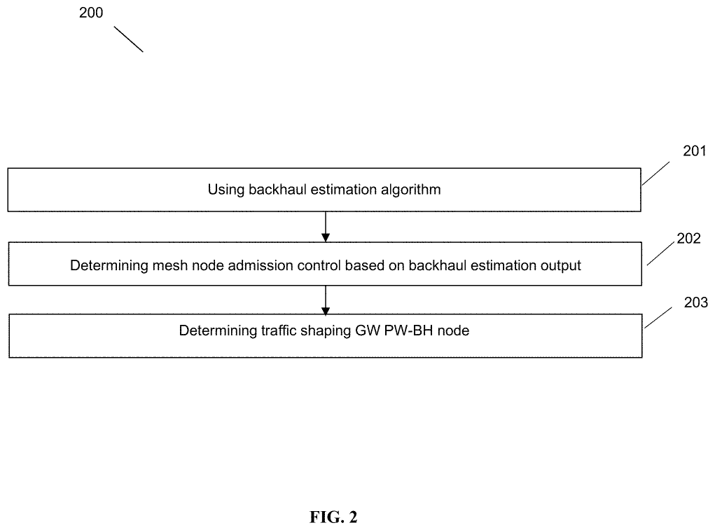

Referring to FIG. 2, a flow diagram 200 is shown regarding the overall bandwidth estimation process. Processing block 201 discloses using a backhaul estimation algorithm. Processing block 202 shows determining mesh node admission control based on backhaul estimation output. Processing block 203 recites determining traffic shaping GW PW-BH node. The \ characteristics are: Trigger point: supported scenario if conditions are meet; Entities involved in the algorithm: PW-BH (GW PW-BH) and HNG (including iPerf Server); Algorithm: Bandwidth estimation as function of iPerf tool; operator configured parameters and in relation to the UL and DL direction.

Scheduling: a number of PW-BH, that have requested to execute the bandwidth estimation, can be scheduled by the HNG for bandwidth estimation execution considering a combined criteria based on the: Maximum number of parallel PW-BH that can be scheduled; Maximum overall HNG related UL/DL bandwidth that can be used by the HNG system for the parallel execution of bandwidth estimation procedure. when the PW-BH(s) in execution will terminate the procedure (with any type of result), one or more (re-)trying PW-BH can be scheduled to make the procedure: the PW-BH that has not been scheduled will receive a denied to the request from the HNGand will continue to (re)try the request if the condition are still meet in the supported scenario.

Failure scenario: If the connection to the iPerf HNG Server is unsuccessful, the PW-BH will continue to (re)try the request based on the retry timer timeout-retry-interval operator configurable parameter; If during the bandwidth estimation procedure execution at least one of the basic conditions (GW node, handbrake on) is no more meet then the procedure is stopped and can restart (i.e. requested again) only if the all the condition are again meet in one of the supported scenario; The above is true also in case of PW-BH/Modem reboot, loss of serving macro happen during the already ongoing procedure execution; In case of HNG Switchover (HNG Standby unit become Active), the PW-BH bandwidth estimation ongoing procedures will fail and, assuming the condition are still met, will retrywith the new HNG Active (where the iPerf server is already configured as per previous HNG Active configuration) instead the value obtained by the PW-BH(s) for which the bandwidth estimation procedure have been already performed with the previous HNG Active, will be still valid in the new HNG Active.

The overall bandwidth estimation process scheme is as following: Bandwidth estimation feature enabling and configuration—this is valid for the HNG and for all theapplicable PW-BH: Bandwidth estimation feature needs to be enabled on both PW-BH and HNG; Bandwidth characterization of the Bandwidth estimation needs to be configured in the HNG; Bandwidth estimation profile needs to be configured and associated to the PW-BH.

Bandwidth estimation profile provisioning to the PW-BH—this is applicable for all the PW-BH forwhich the Bandwidth Estimation profile has been associated.

Bandwidth estimation execution, if condition are meet in the supported scenario—this is applicable for all the PW-BH that meet the conditions in the supported scenario/use case or in case of retry of the procedure.

PW-BH connection and relevant scheduling among the several requesting PW-BH—this is applicable to all the PW-BH that are (re-)trying the bandwidth procedure and then to the ones that have been scheduled by the HNG for the effective procedure. One or more PW-BH(s) are in execution phase while the other are (re)-trying: when one or more of the PW-BH(s) in execution will terminate the procedure (with any type of result), one or more (re-)trying PW-BH(s) can be scheduled for the procedure.

Bandwidth estimation algorithm execution (UL/DL Direction)—this is applicable for each of the PW-BH(s) that have been scheduled/selected. The bandwidth estimation procedure is considered finished if both UL and DL (any type of) results are obtained.

Proper internal system notification of the estimated bandwidth value to the other entities for relevant usage (e.g. for Mesh based Admission Control, Traffic Shaping)—this is applicable for thePW-BH(s) that have been scheduled/selected and that finished properly the bandwidth estimation algorithm execution. In all this context “re-trying” means the PW-BH action to ask again the bandwidth estimationprocedure without referring to the trigger point for it.

The scheduling of the (re-)trying PW-BH for the bandwidth estimation procedure is working as perfollowing overview: the HNG will schedule for the bandwidth estimation procedure execution a (re-)trying PW-BH based on the following combined criteria (the master criteria to not schedule a PW-BH is the firstone that is no more met): No more than 16 parallel PW-BH(s) in bandwidth estimation execution phase per HNG are possible (internal setting); and no more than maximum allowed overall DL and UL bandwidth usage per HNG can be possible for all the parallel PW-BH(s) in bandwidth estimation procedure (operator configurable for each direction separately). The criteria characteristics are: Both criteria must be met at same moment in order to schedule the relevant (re-)trying PW-BH for bandwidth estimation procedure: If the maximum allowed HNG Bandwidth is met (downlink parameter for the DL direction and uplink for the UL direction) but already 16 PW-BH(s) are ongoing inthe bandwidth estimation procedure execution, then the (re-)trying PW-BH will be denied and it will retry indefinitely until when the combined criteria can acceptit, assuming always that the condition to ask the bandwidth estimation are still met; If with the new PW-BH (re-)trying bandwidth estimation procedure still is possibleto meet the maximum 16 parallel PW-BH(s) criteria but the maximum allowed overall HNG Bandwidth criteria (downlink parameter for the DL direction and uplink for the UL direction) is not met at least for a direction, then the (re-)trying PW-BH will be denied and it will retry indefinitely until when the combined criteria can accept it, assuming always that the condition to ask the bandwidth estimation are still met. For the maximum allowed overall DL and UL bandwidth usage per HNG (downlink parameter for the DL direction and uplink for the UL direction) both DL and UL directionsmust be met in order to schedule the relevant (re-) trying PW-BH (assuming that the maximum 16 PW-BH(s) criteria is in any case met): if only one of the direction is satisfiedthen the PW-BH is not scheduled (i.e. is denied); maximum allowed HNG DL and UL bandwidth is considered taking into account the configured downlink and uplink parameters value (maximum-bandwidth container parameter of bandwidth-estimation PW-BH profile) for each PW-BH (re-)trying the bandwidth estimation: due to the assignment of different possible bandwidth-estimationprofile to the PW-BH then it is necessary to consider each single setting for the relevant overall check.

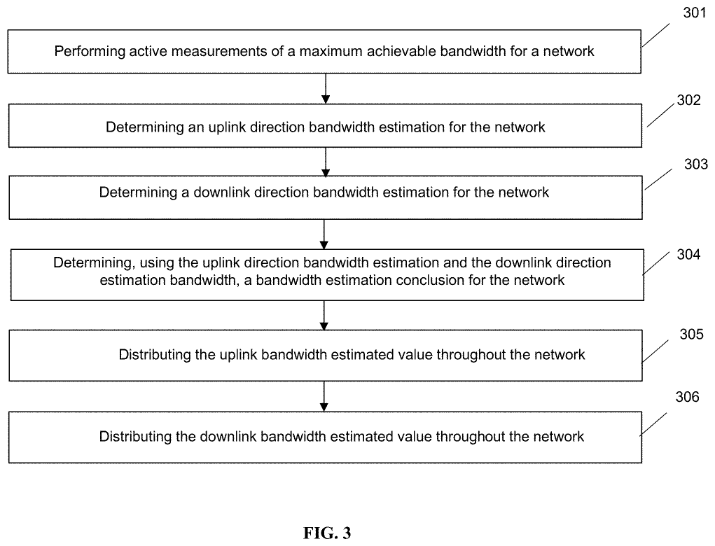

FIG. 3 is a flow diagram for one embodiment of a method 300 for providing backhaul bandwidth estimation for a network. The method begins with processing block 301 which discloses performing active measurements of a maximum achievable bandwidth for the network. In some embodiments the performing active measurements of a maximum achievable bandwidth for the network comprises using an IPerf server.

Processing block 302 shows determining an uplink direction bandwidth estimation for the network. This may include running test execution for a predetermined test-duration time using UDP packets, wherein the UDP packets have a predetermined packet-size and wherein the network has a maximum-bandwidth uplink bandwidth.

Processing block 303 discloses determining a downlink direction bandwidth estimation for the network. This may include running test execution for a predetermined test-duration time using UDP packets, wherein the UDP packets have a predetermined packet-size and wherein the network has a maximum-bandwidth downlink bandwidth.

Processing block 304 shows determining, using the uplink direction bandwidth estimation and the downlink direction estimation bandwidth, a bandwidth estimation conclusion for the network. Processing block 305 recites distributing the uplink bandwidth estimated value throughout the network, and processing block 306 discloses distributing the downlink bandwidth estimated value throughout the network.

Computation of Bandwidth Estimation

In some embodiments, a module on HNG (e.g., coordinating server or edge server) and/or CWS (e.g., base station) can implement bandwidth estimation procedure (SNR based, active estimation etc). On CWS, a traffic monitoring module can also inform Access modules with available bandwidth. In some embodiments a Babel routing protocol can be extended (proprietary) to communicate bandwidth information with-in mesh network.

A traffic monitoring module (CWS), in some embodiments, can perform one or more of the following steps: 1. receive configured SNR-Bandwidth table; 2. Derive UL/DL bandwidth based on SNR report. DL bandwidth can be determined base on SNR and UL bandwidth can be accordingly adjusted (DL:UL=70:25 assumed); 3. If there is change in bandwidth following steps can be performed: 3a. update HNG with changed BW (UL/DL) so that downlink shaping can be modified; 3b. update uplink shaping rules; 3c. update routing module with changed values traffic types (4G data, 3G voice etc); 3d. update Access modules (OamMgr, HnbMgr) with bandwidth info received from routing module.

A traffic monitoring module (HNG), in some embodiments, can perform one or more of the following steps: 1. Update shaping rules based on BW update (NodeInfo) sent by CWS; 2. Determine DL traffic per traffic type and send to CWS.

In some embodiments, in a routing manager, the Babel routing protocol can be extended to communicate available bandwidth between a mesh node (in PS CommHub and Gateway device can be connected over Wired Mesh). “Mesh” as used herein means using other nodes in the known network for backhaul. The routing manager may, in some embodiments: process bandwidth updates from TrafficMon; send nodeinfo to HNG (current available bandwidth); send HELLO msgs with available bandwidth; update TrafficMon with values received in HELLO message.

In some embodiments, a UE modem such as an LTE modem may perform periodic polling for signal quality (polling interval, may be 60 sec), and may update TrafficMon with SNR changes (if the change is >=configured value).

The below description provides another specific example of the bandwidth estimation may be performed.

Logic:

ΣPW-BH scheduled maximum-bandwidth downlink (PW-BH bandwidth-estimation profile)+maximum-bandwidth downlink (PW-BH bandwidth-estimation profile) PW-BH to be scheduled)≤maximum-bandwidth downlink HNG.

ΣPW-BH scheduled maximum-bandwidth uplink (PW-BH bandwidth-estimation profile) +maximum-bandwidth uplink (PW-BH bandwidth-estimation profile) PW-BH to be scheduled)≤maximum-bandwidth uplink HNG.

Parameter related:

ΣPW-BH scheduled interconnect bandwidth-estimation maximum-bandwidth downlink)+(interconnect bandwidth-estimation maximum-bandwidth downlink PW-BH to be scheduled)≤bandwidth-estimation maximum-bandwidth downlink HNG.

ΣPW-BH scheduled interconnect bandwidth-estimation maximum-bandwidth uplink)+(interconnect bandwidth-estimation maximum-bandwidth uplink PW-BH to be scheduled)≤bandwidth-estimation maximum-bandwidth uplink HNG.

### EXAMPLE

assuming the default maximum-bandwidth parameter container of the PW-BH bandwidth-estimation profile (downlink=20 Mbps, uplink=10 Mbps) and the default HNG maximum-bandwidth container parameter (downlink=150 Mbps, uplink=150 Mbps) then maximum 7 PW-BH (due to DL direction restriction to not have more than total HNG DL 150 Mbps bandwidth) parallel bandwidth estimation procedure are possibleeven if exist the “capability” to schedule still other 9 PW-BH looking to just the other criteria (maximum 16 PW-BH(s) in parallel):

DL Direction

6*20 (ΣPW-BH scheduled interconnect bandwidth-estimation maximum-bandwidth downlink)+20 (interconnect bandwidth-estimation maximum-bandwidth downlink PW-BH to be scheduled)≤150 (bandwidth-estimation maximum-bandwidth downlink HNG)

But

7*20 (PW-BH scheduled interconnect bandwidth-estimation maximum-bandwidth downlink)+20 (interconnect bandwidth-estimation maximum-bandwidth downlink PW-BH to be scheduled)>150 (bandwidth-estimation maximum-bandwidth downlink HNG)

UL Direction

6*10 (ΣPW-BH scheduled interconnect bandwidth-estimation maximum-bandwidth uplink)+10 (interconnect bandwidth-estimation maximum-bandwidth uplink PW-BH to be scheduled)≤150 (bandwidth-estimation maximum-bandwidth uplink HNG)

And

7*10 (ΣPW-BH scheduled interconnect bandwidth-estimation maximum-bandwidth uplink)+10 (interconnect bandwidth-estimation maximum-bandwidth uplink PW-BH to be scheduled)≤150 (bandwidth-estimation maximum-bandwidth uplink HNG).

The PW-BH(s) to be scheduled are managed with a FIFO criteria: the (re-)trying PW-BH(s) are considered for the relevant schedule based on the arriving timing of the request; then each one (re-)trying PW-BH will be input to the scheduler as it arrive and scheduled if both the criteria (as per above description) are met: No queue is maintained at HNG level for the not scheduled PW-BH(s): the PW-BH will bereconsidered, as per above methodology, when will it retry the request; If the maximum PW-BH(s) has been scheduled based on the combined criteria, a new onePW-BH can be scheduled only if and when the combined criteria can again permit it; If the maximum allowed HNG DL (downlink) and/or UL (uplink) bandwidth parameter values are changed (increased and/or reduced) then: the ongoing PW-BH(s) in bandwidth estimation procedure execution will continue even if the new configured value is overcome by all the parallel ongoingPW-BH(s) bandwidth estimation procedure; the (re-)trying PW-BH(s) will be scheduled based on the new value just configuredand considering the already ongoing PW-BH(s) bandwidth estimation procedure (still assuming that the maximum 16 PW-BH(s) in parallel execution procedure criteria is met).

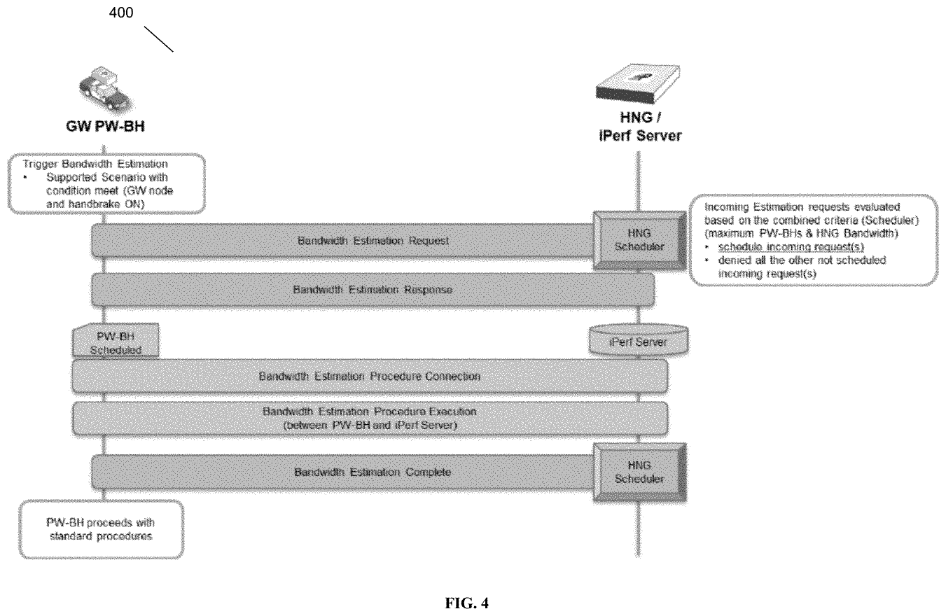

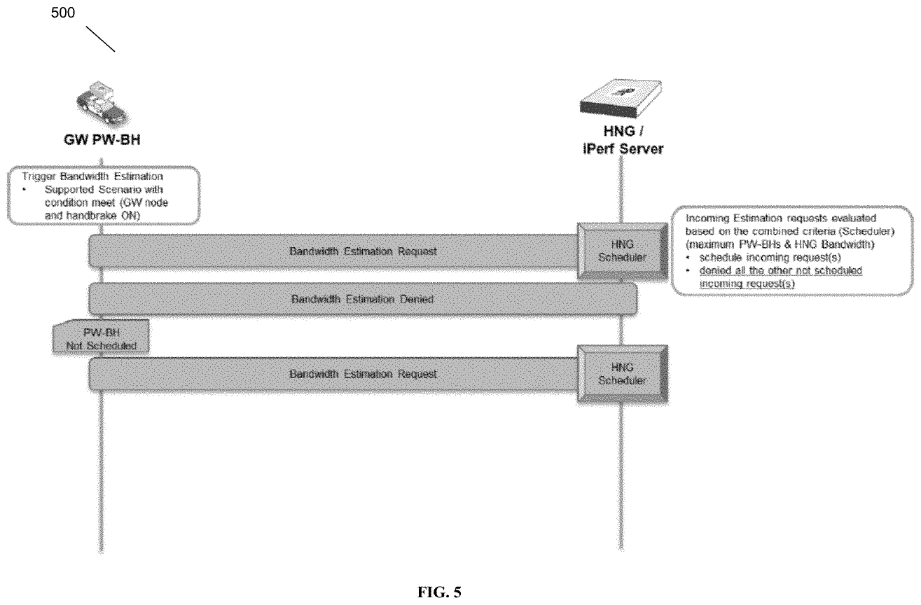

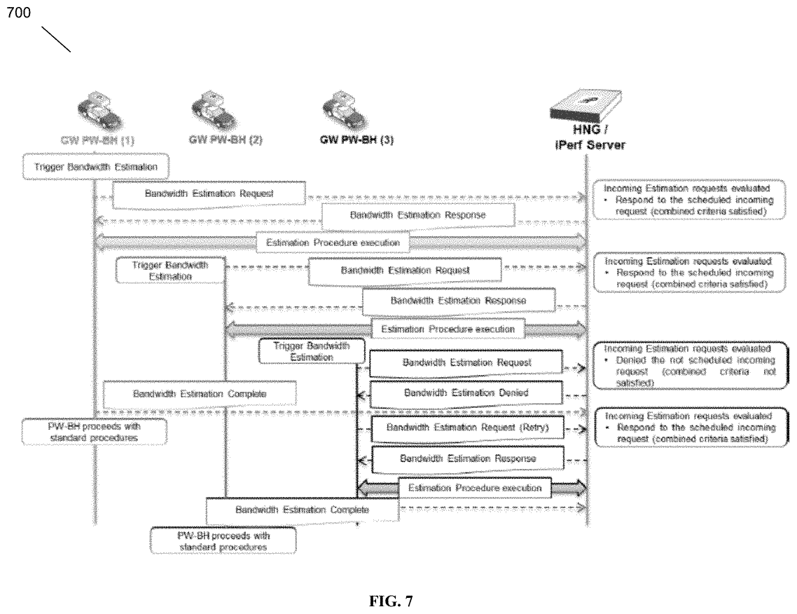

In the following FIGS. (FIGS. 4, 5, 6, 7) are depicted the call flow for the basic procedure related to both positive and negative scenario and an end to end vision of the procedure with an example of multiple GW PW-BHs (re-)trying the bandwidth estimation. FIG. 4 is a diagram showing a Bandwidth Estimation procedure (Positive Scenario) overview 400, in accordance with some embodiments. FIG. 5 is a diagram showing a Bandwidth Estimation procedure (Negative Scenario—Request denied) overview 500, in accordance with some embodiments. FIG. 6 is a diagram showing a Bandwidth Estimation procedure (Negative Scenario—No connection to the iPerf Server) overview 600, in accordance with some embodiments. FIG. 7 is a diagram showing a Bandwidth Estimation procedure—Multiple PW-BH(s) Requests Overview 700, in accordance with some embodiments.

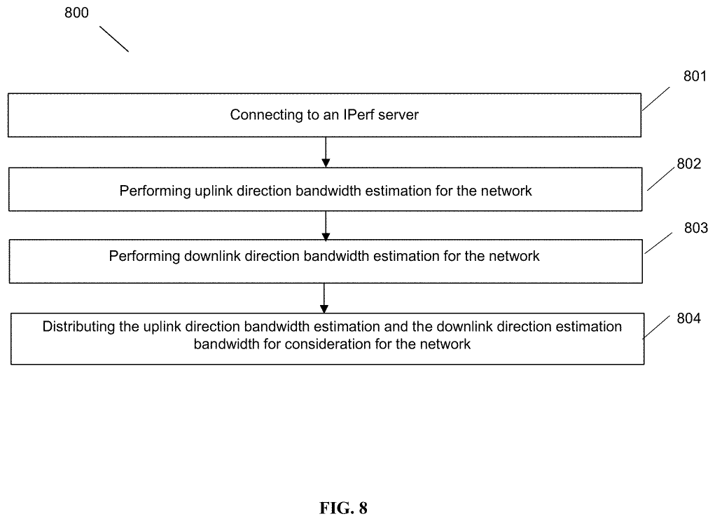

FIG. 8 is a flow diagram showing one embodiment of a process 800 for estimating bandwidth. Processing block 801 discloses connecting to an IPerf server. Processing block 802 shows performing uplink direction bandwidth estimation for the network. Processing block 803 recites performing downlink direction bandwidth estimation for the network. Processing block 804 discloses distributing the uplink direction bandwidth estimation and the downlink direction estimation bandwidth for consideration for the network.

The algorithm itself works with the concept to estimate the bandwidth in one of the supported scenario if the basic condition are meet assuming the proper configuration has been made. In one embodiment of how the bandwidth estimation algorithm works assuming that the PW-BH granted the possibility to execute it (the pre-condition of PW-BH scheduled has been met), that is in any case recapped as “pre-condition step”.

Pre-condition Step: request for bandwidth estimation algorithm execution: GW PW-BH will connect to the HNG for bandwidth estimation procedure request; If the HNG scheduler criteria are met (see chap. 3.5.2 for details), the HNG will providethe relevant permission (the PW-BH has been scheduled) and the port to be used at iPerf HNG Server; if the HNG scheduler is not in the condition to grant the permission to the requesting PW-BH (i.e. the HNG is denying the PW-BH bandwidth estimation procedure request): the HNG will notify the reject to the PW-BH; the PW-BH will retry the procedure request indefinitely until when the permission is granted or the condition are no more meet or no more in one of the supported scenario.

Bandwidth Estimation Algorithm Steps: First Step: connection to the iPerf HNG server; the PW-BH that has been scheduled will start the connection to the iPerf Server using theport that has been assigned by the HNG to the PW-BH when the request for procedure has been accepted (i.e. when the PW-BH has been scheduled); if the connection to the iPerf HNG server is unsuccessful: the PW-BH will issue an event (the CWS was not able to connect to the iPerf Server, trapname pwBwEstConnectivityFailureNotif), in order to inform the operator about the failure situation; the PW-BH will retry the connection each timeout-retry-interval msec operator configurable parameter value, sending each time the above event if connection is still not possible, until when the connection is successful or the condition are no more meet or no more in one of the supported scenario.

Second Step: iPerf test execution: the test will start with the UL Direction. The client will start the test with the uplink parameter value of maximum-bandwidth parameter container as bandwidth and packet-size parameter value for the UDPtraffic; the test is considered completed when the test-duration operator configurable parameter sec has been reached; the test will be repeated for the DL direction in the same fashion and using the relevant similar parameter but for the DL direction (downlink parameter value of the maximum-bandwidth parameter container).

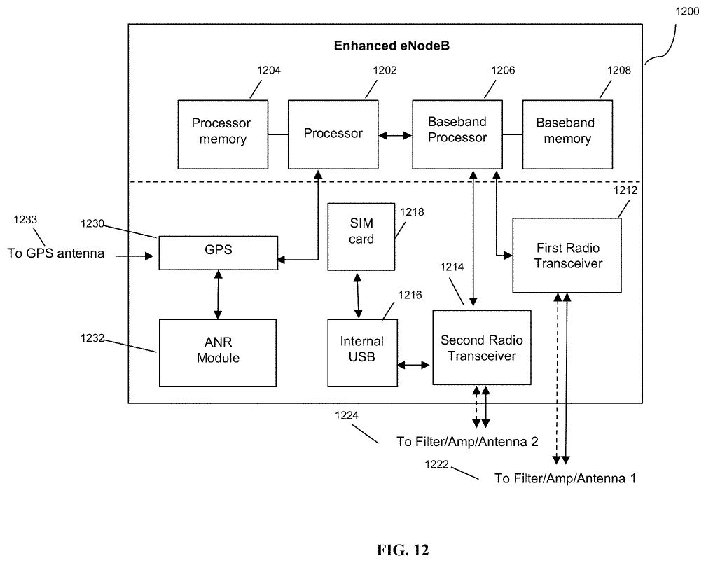

Final Step: internal propagation of the obtained value of estimated bandwidth: the bandwidth estimation procedure is considered finished if both UL and DL (any typeof) results are obtained; internal system notification of the estimated bandwidth values to the other entities forrelevant usage (e.g. for Mesh based Admission Control, Traffic Shaping). FIG. 12 depicts a summary of the above Bandwidth Estimation Algorithm Steps description.

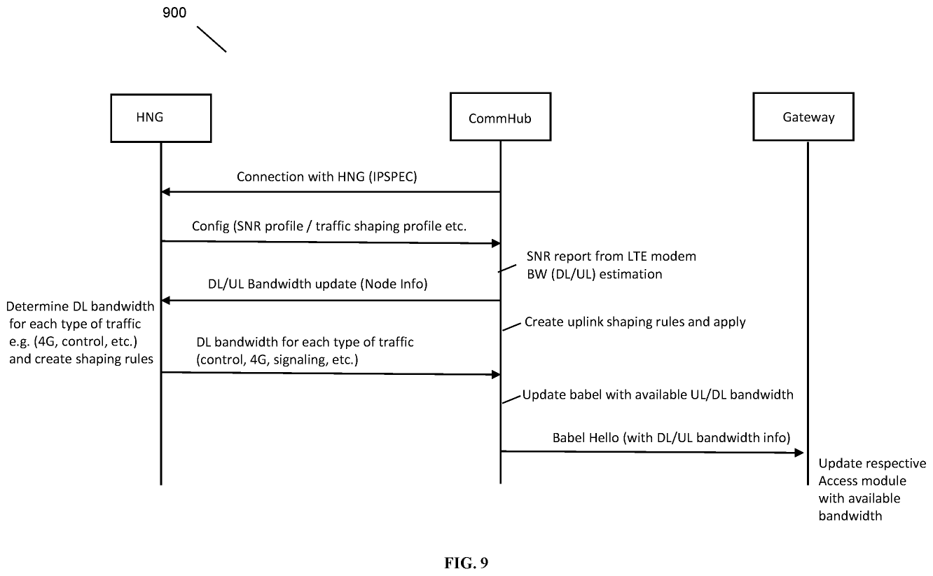

FIG. 9 shows a diagram and devices 900 used for providing bandwidth estimation. This feature is designed to not negatively influence the network performance. Backhaul bandwidth will be estimated without significant impact on the HNG and PW-BH and the possibility to manage the relevant execution based on the framework parameters (e.g. maximum-bandwidth parameters for PW-BH and HNG) is also permitting to better control the possible impact, if any. Also, the (internal) maximum 16 PW-BH(s) in parallel bandwidth estimation procedure is permitting to avoid unnecessary and unexpected impact on the system.

The expectation is to have the entire system configured to qualify and manage the relevant traffic in termsof the best QoS. It is expected to have properly configured all together the relevant features designed forit. This means that, on top of the Traffic Shaping feature, the Backhaul Bandwidth Estimation and Mesh node Admission Control features will be enabled(configured)/disabled together.

This feature is designed to not negatively influence the network performance. Backhaul bandwidth will be estimated without significant impact on the HNG and PW-BH and the possibility to manage the relevant execution based on the framework parameters (e.g. maximum-bandwidth parameters for PW-BH and HNG) is also permitting to better control the possible impact, if any. Also, the (internal) maximum 16 PW-BH(s) in parallel bandwidth estimation procedure is permitting to avoid unnecessary and unexpected impact on the system.

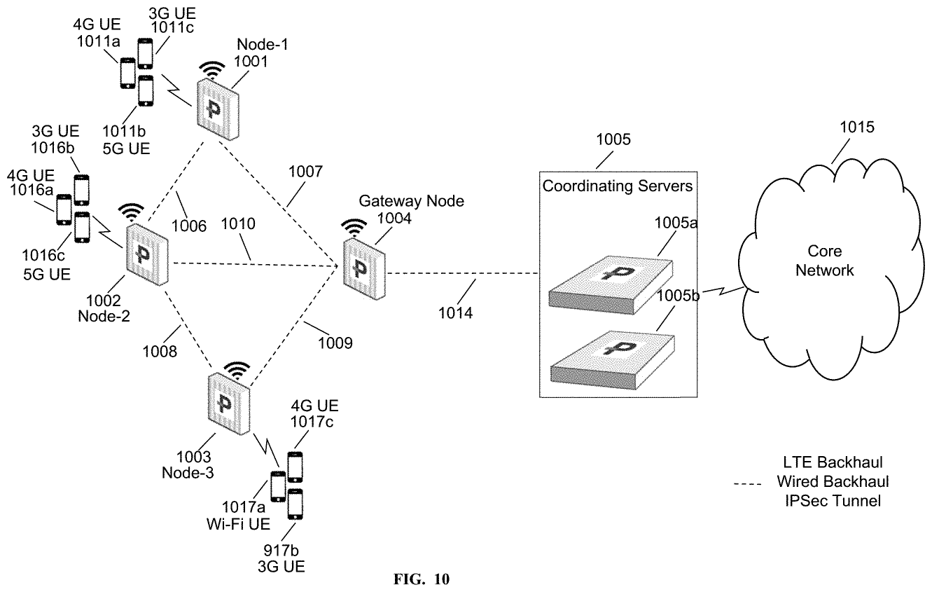

FIG. 10 a network diagram in accordance with some embodiments. In some embodiments, as shown in FIG. 10, a mesh node 1 901, a mesh node 2 1002, and a mesh node 3 1003 are any G RAN nodes. Base stations 101, 1002, and 1003 form a mesh network establishing mesh network links 1006, 1007, 1008, 1009, and 1010 with a base station 1004. The mesh network links are flexible and are used by the mesh nodes to route traffic around congestion within the mesh network as needed. The base station 1004 acts as gateway node or mesh gateway node, and provides backhaul connectivity to a core network to the base stations 1001, 1002, and 1003 over backhaul link 1014 to a coordinating server(s) 1005 and towards core network 1015. The Base stations 1001, 1002, 1003, 1004 may also provide eNodeB, NodeB, Wi-Fi Access Point, Femto Base Station etc. functionality, and may support radio access technologies such as 2G, 3G, 4G, 5G, Wi-Fi etc. The base stations 1001, 1002, 1003 may also be known as mesh network nodes 1001, 1002, 1003.

The coordinating servers 1005 are shown as two coordinating servers 1005a and 1005b. The coordinating servers 1005a and 1005b may be in load-sharing mode or may be in active-standby mode for high availability. The coordinating servers 1005 may be located between a radio access network (RAN) and the core network and may appear as core network to the base stations in a radio access network (RAN) and a single eNodeB to the core network, i.e., may provide virtualization of the base stations towards the core network. As shown in FIG. 10, various user equipments 1011a, 1011b, 1011c are connected to the base station 1001. The base station 1001 provides backhaul connectivity to the user equipments 1011a, 1011b, and 1011c connected to it over mesh network links 1006, 1007, 1008, 1009, 1010 and 1014. The user equipments may be mobile devices, mobile phones, personal digital assistant (PDA), tablet, laptop etc. The base station 1002 provides backhaul connection to user equipments 1012a, 1012b, 1012c and the base station 1003 provides backhaul connection to user equipments 1013a, 1013b, and 1013c. The user equipments 1011a, 1011b, 1011c, 1012a, 1012b, 1012c, 1013a, 1013b, 1013c may support any radio access technology such as 2G, 3G, 4G, 5G, Wi-Fi, WiMAX, LTE, LTE-Advanced etc. supported by the mesh network base stations, and may interwork these technologies to IP.

In some embodiments, depending on the user activity occurring at the user equipments 1011a, 1011b, 1011c, 1012a, 1012b, 1012c, 1013a, 1013b, and 1013c, the uplink 1014 may get congested under certain circumstances. As described above, to continue the radio access network running and providing services to the user equipments, the solution requires prioritizing or classifying the traffic based at the base stations 1001, 1002, 1003. The traffic from the base stations 1001, 1002, and 1003 to the core network 1015 through the coordinating server 1005 flows through an IPSec tunnel terminated at the coordinating server 1005. The mesh network nodes 1001, 1002, and 1003 adds IP Option header field to the outermost IP Header (i.e., not to the pre-encapsulated packets). The traffic may from the base station 1001 may follow any of the mesh network link path such as 1007, 1006-110, 1006-108-109 to reach to the mesh gateway node 1004, according to a mesh network routing protocol.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art. Additionally, the inventors have contemplated the use of in-band or out-of-band backhaul and other mesh topologies and architectures. Additionally, the inventors have understood that any RAN, any RAT can be supported using a mesh backhaul, as described herein, and thus the present disclosure relates to backhaul management for any RAT.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

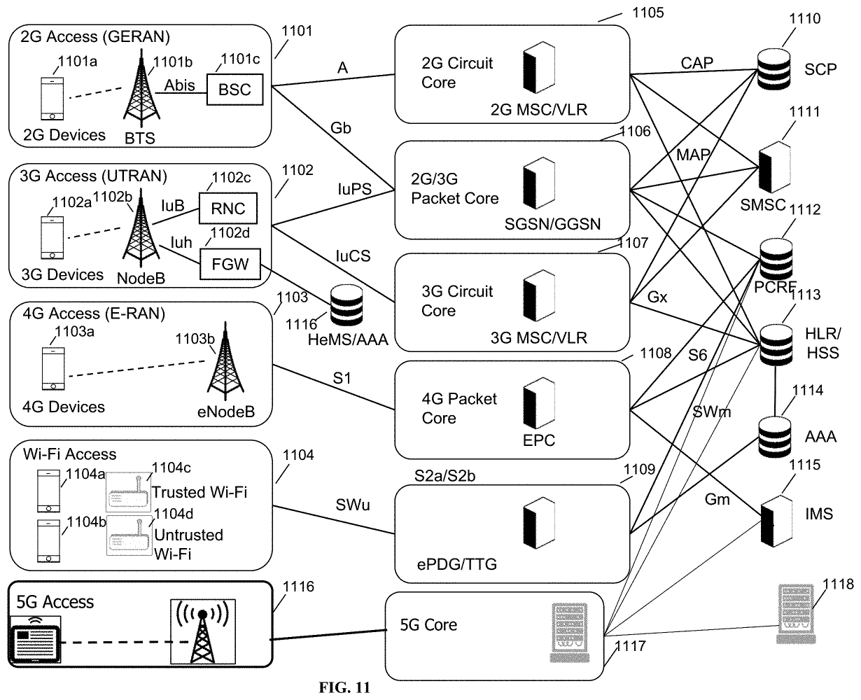

FIG. 11 is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 1101a, BTS 1101b, and BSC 1101c. 3G is represented by UTRAN 1102, which includes a 3G UE 1102a, nodeB 1102b, RNC 1102c, and femto gateway (FGW, which in 3GPP namespace is also known as a Home nodeB Gateway or HNBGW) 1102d. 4G is represented by EUTRAN or E-RAN 1103, which includes an LTE UE 1103a and LTE eNodeB 1103b. Wi-Fi is represented by Wi-Fi access network 1104, which includes a trusted Wi-Fi access point 1104c and an untrusted Wi-Fi access point 1104d. The Wi-Fi devices 1104a and 1104b may access either AP 1104c or 1104d. In the current network architecture, each “G” has a core network. 2G circuit core network 1105 includes a 2G MSC/VLR; 2G/3G packet core network 1106 includes an SGSN/GGSN (for EDGE or UMTS packet traffic); 3G circuit core 1107 includes a 3G MSC/VLR; 4G circuit core 1108 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 1130, the SMSC 1131, PCRF 1132, HLR/HSS 1133, Authentication, Authorization, and Accounting server (AAA) 1134, and IP Multimedia Subsystem (IMS) 1135. An HeMS/AAA 1136 is present in some cases for use by the 3G UTRAN. The diagram is used to indicate schematically the basic functions of each network as known to one of skill in the art, and is not intended to be exhaustive. For example, 11G core 1117 is shown using a single interface to 11G access 1116, although in some cases 11G access can be supported using dual connectivity or via a non-standalone deployment architecture.

Noteworthy is that the RANs 1101, 1102, 1103, 1104 and 1136 rely on specialized core networks 1105, 1106, 1107, 1108, 1109, 1137 but share essential management databases 1130, 1131, 1132, 1133, 1134, 1135, 1138. More specifically, for the 2G GERAN, a BSC 1101c is required for Abis compatibility with BTS 1101b, while for the 3G UTRAN, an RNC 1102c is required for Iub compatibility and an FGW 1102d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

FIG. 12 is an enhanced eNodeB for performing the methods described herein, in accordance with some embodiments. Mesh network node 1200 may include processor 1102, processor memory 1204 in communication with the processor, baseband processor 1206, and baseband processor memory 1208 in communication with the baseband processor. Mesh network node 1200 may also include first radio transceiver 1212 and second radio transceiver 1214, internal universal serial bus (USB) port 1216, and subscriber information module card (SIM card) 1218 coupled to USB port 1216. In some embodiments, the second radio transceiver 1214 itself may be coupled to USB port 1216, and communications from the baseband processor may be passed through USB port 1216. The second radio transceiver may be used for wirelessly backhauling eNodeB 1200.

Processor 1202 and baseband processor 1206 are in communication with one another. Processor 1202 may perform routing functions, and may determine if/when a switch in network configuration is needed. Baseband processor 1206 may generate and receive radio signals for both radio transceivers 1212 and 1214, based on instructions from processor 1202. In some embodiments, processors 1202 and 1206 may be on the same physical logic board. In other embodiments, they may be on separate logic boards.

Processor 1202 may identify the appropriate network configuration, and may perform routing of packets from one network interface to another accordingly. Processor 1202 may use memory 1204, in particular to store a routing table to be used for routing packets. Baseband processor 1206 may perform operations to generate the radio frequency signals for transmission or retransmission by both transceivers 1210 and 1212. Baseband processor 1206 may also perform operations to decode signals received by transceivers 1212 and 1214. Baseband processor 1206 may use memory 1208 to perform these tasks.

The first radio transceiver 1212 may be a radio transceiver capable of providing LTE eNodeB functionality, and may be capable of higher power and multi-channel OFDMA. The second radio transceiver 1214 may be a radio transceiver capable of providing LTE UE functionality. Both transceivers 1212 and 1214 may be capable of receiving and transmitting on one or more LTE bands. In some embodiments, either or both of transceivers 1212 and 1214 may be capable of providing both LTE eNodeB and LTE UE functionality. Transceiver 1212 may be coupled to processor 1202 via a Peripheral Component Interconnect-Express (PCI-E) bus, and/or via a daughtercard. As transceiver 1214 is for providing LTE UE functionality, in effect emulating a user equipment, it may be connected via the same or different PCI-E bus, or by a USB bus, and may also be coupled to SIM card 1218. First transceiver 1212 may be coupled to first radio frequency (RF) chain (filter, amplifier, antenna) 1222, and second transceiver 1214 may be coupled to second RF chain (filter, amplifier, antenna) 1224.

SIM card 1218 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 1200 is not an ordinary UE but instead is a special UE for providing backhaul to device 1200.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 1212 and 1214, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 1202 for reconfiguration.

A GPS module 1230 may also be included, and may be in communication with a GPS antenna 1232 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 1232 may also be present and may run on processor 1202 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

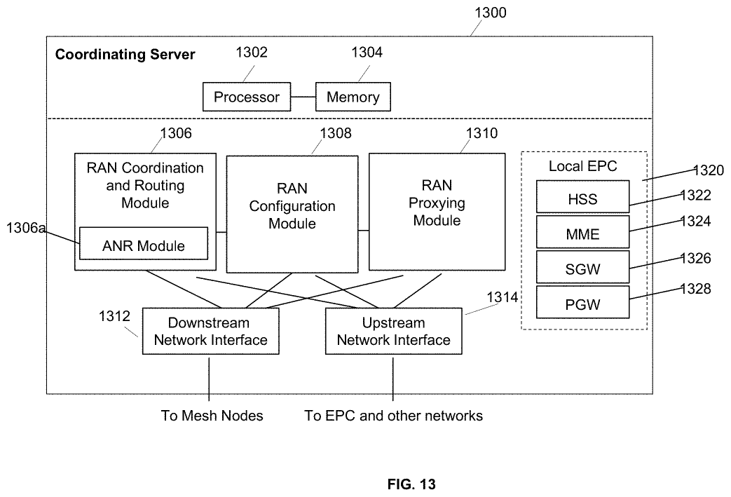

FIG. 13 is a coordinating server for providing services and performing methods as described herein, in accordance with some embodiments. Coordinating server 1200 includes processor 1302 and memory 1304, which are configured to provide the functions described herein. Also present are radio access network coordination/routing (RAN Coordination and routing) module 1306, including ANR module 1306a, RAN configuration module 1308, and RAN proxying module 1310. The ANR module 1306a may perform the ANR tracking, PCI disambiguation, ECGI requesting, and GPS coalescing and tracking as described herein, in coordination with RAN coordination module 1306 (e.g., for requesting ECGIs, etc.). In some embodiments, coordinating server 1300 may coordinate multiple RANs using coordination module 1306. In some embodiments, coordination server may also provide proxying, routing virtualization and RAN virtualization, via modules 1310 and 1308. In some embodiments, a downstream network interface 1312 is provided for interfacing with the RANs, which may be a radio interface (e.g., LTE), and an upstream network interface 1314 is provided for interfacing with the core network, which may be either a radio interface (e.g., LTE) or a wired interface (e.g., Ethernet).

Coordinator 1300 includes local evolved packet core (EPC) module 1320, for authenticating users, storing and caching priority profile information, and performing other EPC-dependent functions when no backhaul link is available. Local EPC 1320 may include local HSS 1322, local MME 1324, local SGW 1326, and local PGW 1328, as well as other modules. Local EPC 1320 may incorporate these modules as software modules, processes, or containers. Local EPC 1320 may alternatively incorporate these modules as a small number of monolithic software processes. Modules 1306, 1308, 1310 and local EPC 1320 may each run on processor 1302 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for providing backhaul bandwidth estimation for a network, comprising:
performing active measurements of a maximum achievable bandwidth for the network;
determining an uplink direction bandwidth estimation for the network;
determining a downlink direction bandwidth estimation for the network; and
determining, using the uplink direction bandwidth estimation and the downlink direction estimation bandwidth, a bandwidth estimation conclusion for the network.

2. The method of claim 1, wherein the performing active measurements of a maximum achievable bandwidth for the network comprises using an IPerf server.

3. The method of claim 1 wherein determining an uplink direction bandwidth estimation for the network comprises running test execution for a predetermined test-duration time using UDP packets.

4. The method of claim 3 wherein the UDP packets have a predetermined packet-size.

5. The method of claim 3 wherein the network has a maximum-bandwidth uplink bandwidth.

6. The method of claim 1 wherein determining a downlink direction bandwidth estimation for the network comprises running test execution for a predetermined test-duration time using UDP packets. The method of claim 6 wherein the UDP packets have a predetermined packet-size.

8. The method of claim 6 wherein the network has a maximum-bandwidth downlink bandwidth.

9. The method of claim 1 further comprising distributing the uplink bandwidth estimated value throughout the network.

10. The method of claim 1 further comprising distributing the downlink bandwidth estimated value throughout the network.

11. A non-transitory computer-readable medium containing instructions for providing backhaul bandwidth estimation for a network that when executed, causes a network to perform steps comprising:
performing active measurements of a maximum achievable bandwidth for the network;
determining an uplink direction bandwidth estimation for the network;
determining a downlink direction bandwidth estimation for the network; and
determining, using the uplink direction bandwidth estimation and the downlink direction estimation bandwidth, a bandwidth estimation conclusion for the network.

12. The non-transitory computer-readable medium of claim 11, wherein the instructions for performing active measurements of a maximum achievable bandwidth for the network comprises instructions for using an IPerf server.

13. The non-transitory computer-readable medium of claim 11, wherein instructions for determining an uplink direction bandwidth estimation for the network comprises instructions for running test execution for a predetermined test-duration time using UDP packets.

14. The non-transitory computer-readable medium of claim 13, wherein the UDP packets have a predetermined packet-size.

15. The non-transitory computer-readable medium of claim 13, wherein the network has a maximum-bandwidth uplink bandwidth.

16. The non-transitory computer-readable medium of claim 11, wherein instructions for determining a downlink direction bandwidth estimation for the network comprises instructions for running test execution for a predetermined test-duration time using UDP packets.

17. The non-transitory computer-readable medium of claim 16, wherein the UDP packets have a predetermined packet-size.

18. The non-transitory computer-readable medium of claim 16, wherein the network has a maximum-bandwidth downlink bandwidth.

19. The non-transitory computer-readable medium of claim 11, further comprising instructions for distributing the uplink bandwidth estimated value throughout the network.

20. The non-transitory computer-readable medium of claim 11, further comprising instructions for distributing the downlink bandwidth estimated value throughout the network.
